(19) United States
(12) Patent Application Publication
(10) Pub. No.: US 2006/0037005 A1
(43) Pub. Date: Feb. 16, 2006

(54) Method and apparatus for increasing computer security

(76) Inventor: Paul F. Russell, Queanbeyan (AU)

Correspondence Address: LAW OFFICES OF MICHAEL DRYJA, 704 228TH AVENUE NE, PMB 694, SAMMAMISH, WA, 98074, US

(21) Appl. No.: 10/919,510

(22) Filed: Aug. 15, 2004

(51) Int. Cl. G06F 9/44

(52) U.S. Cl. 717/134; 717/138

(57) ABSTRACT

Generating pseudo computer architectures for security, so that malicious software written to run on existing computer architectures is unable to run on the pseudo computer architectures, is disclosed. A method generates an pseudo computer architecture, and emulates this pseudo computer architecture. An existing computer architecture may be altered to generate the pseudo computer architecture. The pseudo computer architecture may be emnulated by software running on an existing computer architecture, via hardware, or by programming a programmable processor based on the pseudo computer architecture. The method performs a process to allow computer programs to run on the pseudo computer architecture. Executable binary code files for the computer programs may be generated, based on the pseudo computer architecture, from source code files for the computer programs. The binary code files for the computer programs that are runnable on existing computer architectures may also be modified to run on the pseudo computer architecture.

### FIELD OF THE INVENTION

The present invention relates generally to computer architectures, and more particularly to generating pseudo computer architectures for security purposes, so that malicious software written to run on existing computer architectures is unable to run on the pseudo computer architectures.

### BACKGROUND OF THE INVENTION

A computer system generally includes at least a computer architecture, or a hardware platform, and computer programs that run on the computer architecture, such as operating systems and application programs that are executed within the context of such operating systems. A computer architecture, or hardware platform, can be defined as at least a portion of the hardware that executes instructions of computer programs. A computer architecture is characterized by the type of machine language that processors compatible with the computer architecture can understand. The machine language of a computer architecture can be defined as the set of operation codes, or opcodes, that can be directly executed by processors compatible with the computer architecture. An operation code is the most basic level of instruction that a processor can execute.

Common computer architectures include the x86, IA-64, 680x0, SPARC, PowerPC, and ARM architectures. Each of these computer architectures has a machine language that is different than the machine languages of the other computer architectures. For instance, the x86 computer architecture cannot understand the machine language of the SPARC computer architecture, and vice-versa. Each computer architecture usually has a number of different compatible processors, which are processors or central processing units (CPU's) capable of understanding the operation codes of the machine language of the computer architecture. For instance, Pentium® processors available from Intel Corp., of Santa Clara, Calif., Athlon™ processors available from Advanced Micro Devices, Inc., of Sunnyvale, Calif., as well as various processors available from VIA Technologies, Inc., of Taipei, Taiwan, all are compatible with and support the machine language of the x86 computer architecture.

Computer programs intended to be run on a given computer architecture include instructions that are able to be executed by processors of that computer architecture. More specifically, the executable binary code files of computer programs include instructions that the processors are able to execute. Computer programs are generally developed in user-readable source code, and then are compiled and linked to result in the binary code that the processors compatible with a given architecture can execute. The binary code files of computer programs that can be executed within one computer architecture typically cannot be executed within a different computer architecture. That is, binary code files are computer architecture dependent.

The vast majority of computer systems currently run versions of the Windows® operating system, available from Microsoft Corp., of Redmond, Wash. In turn, the vast majority of computer systems running versions of the Windows(& operating system employ the x86 computer architecture. This means that all the computer systems worldwide as a whole lack any significant diversity as to their computer architectures, and instead are rather monolithic in their computer architectures. The lack of diversity in computer architectures can be advantageous in that hardware and software developers can reach a large majority of potential customers by designing products that can be used with only the x86 computer architecture. In turn, users benefit because there is a large variety of different types of inexpensive hardware and software from which to choose.

However, with the increasing popularity of the Internet, more and more computer systems are becoming communicatively interconnected with one another, exposing a serious disadvantage in the lack of diversity in the computer architectures of the world's computer systems. This serious disadvantage is that computer systems worldwide are increasingly vulnerable to attacks from malicious, or rogue, software, such as computer viruses, worms, logic bombs, rootkits, and Trojan horses, which can easily and quickly spread to computer systems around the globe due to their common connection to the Internet. Because of the monolithic nature of the computer architectures of these computer systems, a sinister developer has only to create malicious software that runs on one type of computer architecture, the x86 computer architecture, to potentially be able to infect the vast majority of computer systems in existence.

The veritable explosion of malicious software that the computing community has witnessed is predicted only to grow worse, especially as pranksters developing such software yield to organized crime and other criminal elements in being a primary source of malicious software. The current approach to managing malicious software has been to install firewalls and anti-virus tools on computer systems. Firewalls can be implemented in hardware and software, and inspect computer communication traffic coming out of and/or into a computer system for evidence that malicious software is responsible for such communication traffic, so that the traffic can be terminated. Anti-virus tools can also be implemented in hardware and software, and usually inspect common locations of malicious software, such as email, hard disk drives, arid memory, either on a real-time or scheduled basis, so that any malicious software can be detected and removed.

However, firewalls and anti-virus tools, as well as other current approaches to managing malicious software, are imperfect. Firewalls, for example, may not be able to discern legitimate computer communication traffic from computer communication traffic originating from malicious software. As a result, either legitimate traffic may be erroneously terminated, or illegitimate traffic may be erroneously permitted to continue. Furthermore, anti-virus tools usually have to be upgraded on a frequent basis in order to maintain their effectiveness against new malicious software threats that can abound on a daily basis, and many users forget or choose not to upgrade them. The continued spread of malicious software on computer systems even in the face of the usage of firewalls and anti-virus tools indeed is evidence of their ineffectiveness to stem the tide of insidious malicious software.

### SUMMARY OF THE INVENTION

The invention relates to generating pseudo computer architectures for security purposes, so that malicious software written to run on existing computer architectures is unable to run on the pseudo computer architectures. A method of an embodiment of the invention generates an pseudo computer architecture, and emulates the generated computer architecture. For instance, an existing computer architecture may be altered to generate the pseudo computer architecture. The pseudo computer architecture may be emulated by software running on the existing computer architecture, via hardware, or by programming a programmable or flexible processor with the machine language of the pseudo computer architecture. The method also performs a process to allow computer programs to run on the pseudo computer architecture. Executable binary code files for the computer programs may be generated, based on the machine language of the pseudo computer architecture, from source code files for the computer programs. As another example, the binary code files for the computer programs that are runnable on an existing computer architecture may be modified to run on the pseudo computer architecture that has been generated.

A system of an embodiment of the invention includes an pseudo computer architecture and one or more computer programs, as well as preferably an emulator. The pseudo computer architecture is different than the existing computer architectures, so that malicious software written to run on the existing computer architectures is unable to run on the pseudo computer architecture. The programs are originally intended to run on an existing computer architecture, but have been modified to instead run on the pseudo computer architecture. The emulator emulates the pseudo computer architecture, either in software, so that the pseudo computer architecture is implementable with existing hardware, or in hardware. If the emulator is implemented in hardware, the resulting hardware emulator may include a programmable processor that can be programmed in accordance with the pseudo computer architecture.

An article of manufacture of an embodiment of the invention includes a computer-readable medium and means in the medium. The means is for providing an pseudo computer architecture that is different than existing computer architectures, so that malicious software written to run on the existing computer architectures is unable to run on the pseudo computer architectures. Computer programs originally intended to run on an existing computer architecture have to be modified to instead be run on the pseudo computer architecture.

Embodiments of the invention provide for advantages over the prior art. Generating pseudo computer architectures introduces pseudo diversity in the computer architectures of computer systems. As a result, malicious software executable on actual existing computer architectures cannot run on the pseudo computer architectures generated, inherently protecting the computer systems having these pseudo computer architectures from attack by such software. The pseudo computer architectures are pseudo in that they do not correspond to any existing hardware. That is, no processors may exist to natively run the machine languages of the pseudo computer architectures without being programmed to do so, and indeed the purpose in generating the pseudo computer architectures is not so that processors can be later designed to natively run within such computer architectures. Rather, the purpose is to generate pseudo computer architectures that are purposefully at least somewhat different from existing computer architectures, so that malicious software written for existing computer architectures cannot infect computer systems having such pseudo computer architectures.

The pseudo computer architecture for a given computer system may be regenerated on a regular basis, to provide further protection against malicious software that may be developed to try to match the machine language of the pseudo computer architecture in order to attack the computer system. Generating the pseudo computer architecture can be a random, pseudo-random, or purposefully designed process. At one extreme, the generation process may involve simple alterations of existing computer architectures sufficient enough to prevent malicious computer programs runnable on the existing computer architectures from running on the newly generated pseudo computer architectures. At the other extreme, the generation process may entail sophisticated designs of pseudo computer architectures wholly different than the existing computer architectures. The end result is the same, however, which is to lend pseudo computer architecture diversity to a given computer system, so that the problems that plague the monolithic computer architecture culture of existing computer systems cannot be transmitted to the given system.

Still other advantages, aspects, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram depicting a computer system having an existing computer architecture and a computer system having an pseudo computer architecture, such that the former computer architecture is more vulnerable to malicious software than the latter computer architecture is, according to an embodiment of the invention.

FIG. 2 is a flowchart of a method for enhancing security of a computer system through an pseudo computer architecture, according to an embodiment of the invention.

FIG. 3 is a diagram depicting alteration of the machine language of an existing computer architecture to generate the machine language of an pseudo computer architecture, according to an embodiment of the invention.

FIG. 4 is a diagram of a programmable or flexible processor programmed to emulate an pseudo computer architecture, according to an embodiment of the invention.

FIG. 5 is a diagram depicting modification of the different components of a toolchain to enable computer programs to run on an pseudo computer architecture, according to an embodiment of the invention.

FIG. 6 is a diagram depicting modification of executable binary code files for a computer program with respect to an existing computer architecture to instead run on an pseudo computer architecture, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

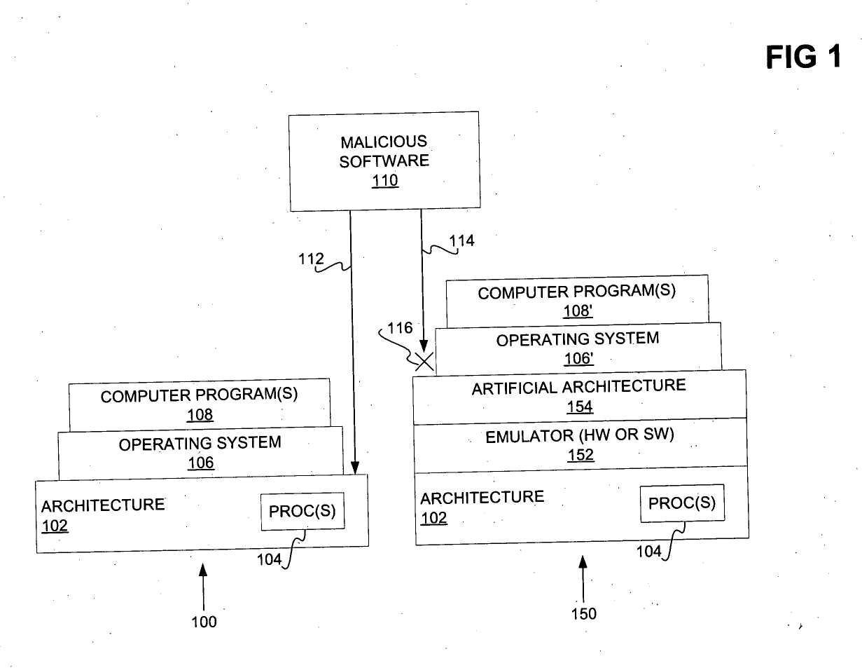

FIG. 1 shows a computer system 100 having a conventional computer architecture 102 and a computer system 150 having an pseudo computer architecture 154, according to an embodiment of the invention. A computer architecture may also be referred to as a hardware platform, and can be defined as at least a portion of the hardware that executes instructions of computer programs, such as application computer programs, operating systems, as well as other types of computer programs. A computer architecture is characterized by the type of machine language that processors compatible with the computer architecture can understand. The machine language of a computer architecture can be defined as the set of operation codes, or opcodes, that can be directly executed by processors compatible with the computer architecture. An operation code is the most basic level of instruction that a processor can execute.

The conventional computer architecture 102 may an x86, IA-64, 680x0, SPARC, PowerPC, ARM, or another type of architecture. The computer architecture 102 includes one or more processors 104, or central processing units (CPU's), that are capable of understanding the operation codes of the machine language of the computer architecture 102. For instance, where the architecture 102 is the x86 architecture, the processors 104 may be Pentium® processors, Athlon™ processors, processors available from VIA Technologies, or other types of processors that are able to execute the x86 machine language. The computer architecture 102 is a conventional architecture in that it is a commercially available architecture that has relatively widespread usage on computers throughout the world. Furthermore, the computer architecture 102 is a conventional architecture in that the processors 104 are designed to directly understand the machine language of the computer architecture 102.

An operating system 106 can be considered as running on top of or within the computer architecture 102. There may be further low-level software components between the operating system 106 and the computer architecture 102, as can be appreciated by those of ordinary skill within the art, but such components are not depicted in FIG. 1 for illustrative clarity. The operating system 106 can be considered as the master control program that runs the computer system 100. The operating system 106 sets the standards for all or nearly all of the other computer programs 108 that run on the system 100. The computer programs 108 communicate with the operating system 106 for user interface operations, job management operations, file management operations, task and data management operations, device management operations, as well as other types of operations. The computer programs 108 may be considered as running on top of or within the operating system 106. The operating system 106 is itself a special type of computer program or programs.

The operating system 106, as well as the computer programs 108 contain instructions that are particularly executable only on the computer architecture 102, by the processors 104 thereof. That is, the operating system 106 and the computer programs 108 each specifically include one or more binary code files that in sum encompass the operating system 106 or one of the computer programs 108. The binary code files may be compiled, linked, and/or assembled from source code files that are written by developers in a user-readable format. The resulting binary code files are directly understandable by the processors 104 of the computer architecture 102. That is, the instructions of the operating system 106 and the computer programs 108 are sequences of the operation codes of the machine language of the computer architecture 102, to cause the computer system 100 to operate in a desired manner. The binary code files of the operating system 106 and the computer programs 108 thus intended to run on the computer architecture 102 can only run on the computer architecture 102, and not on other, incompatible computer architectures.

The computer system 150 also includes the conventional computer architecture 102 with its one or more processors 104. However, the pseudo computer architecture 154 runs on top of or within the computer architecture 102. The pseudo computer architecture 154 has a different machine language than the computer architecture 102 does. Thus, the operating system 106′ and the computer programs 108′ have binary code files that are able to run on the pseudo computer architecture 154, but not on the underlying conventional computer architecture 102. The pseudo computer architecture 154 is pseudo in that it does not correspond to any existing hardware, and is not intended to correspond to any existing hardware. That is, no processors may exist to natively run the machine language of the pseudo computer architecture 154 without being particularly programmed to do so, if this is even possible, and the purpose in generating the pseudo computer architecture 154 is not so that processors can be later designed to natively and directly run within such computer architectures.

The pseudo computer architecture 154 may be considered a virtual computer architecture in that it may not actually encompass hardware, such as processors, the way the existing conventional computer architecture 102 does. However, the computer architecture 154 is not to be confused with the concept known as virtualization, which provides for a virtual computer. A virtual computer, or partition, of a computer system is an instance of an operating system that can run on the same computer architecture along with other instances of the same or different operating systems. By comparison, the pseudo computer architecture 154 is a differently defined computer architecture than the existing computer architecture 102, and is virtual only in the sense that it may not encompass hardware as the computer architecture 102 does. The pseudo computer architecture 154 may or may not be able to support virtual computers, or partitions, such that it is conceptually different than virtualization.

In the embodiment of FIG. 1, an emulator 152 enables the pseudo computer architecture 154 to run on the existing conventional computer architecture 102. The emulator 152 may be hardware, software, or a combination of hardware or software. A hardware emulator generally has the advantage of enabling the pseudo computer architecture 154 to perform nearly as well as the existing conventional computer architecture 102, but may have the disadvantage of being difficult to design, develop, implement, and/or build. A software emulator running on the conventional computer architecture 102 generally has the advantage of being easier to design, develop, implement, and/or build, but may have the disadvantage of causing the pseudo computer architecture 154 to perform markedly slower than the existing conventional hardware computer architecture 102.

The emulator 152 enables the pseudo computer architecture 154 to run on the existing conventional computer architecture 102 by translating the operation codes of the machine language of the pseudo computer architecture 154 to operation codes of the machine language of the conventional computer architecture 102. For instance, each instruction of the binary code files of the computer programs 108′ and the operating system 106′ may specify one or more operation codes of the machine language of the pseudo computer architecture 154. So that the processors 104 of the computer architecture 102 are able to execute these operation codes, the emulator 152 first translates them to operation codes of the machine language of the computer architecture 102 that is understood by the processors 104.

The operating system 106′ and the computer programs 108′ thus contain instructions that are particularly executable only on the pseudo computer architecture 154. The operating system 106′ and the computer programs 108′ correspond to the operating system 106 and the computer programs 108 of the computer system 100, except that their binary code files contain instructions that are understood only by the pseudo computer architecture 154, and not by the existing computer architecture 102. As such, the binary code files that make up the operating system 106′ and the computer programs 108′ that run on top of or within the operating system 106′ may be compiled, linked, and/or assembled form the same source code files as the operating system 106 and the computer programs 108. However, whereas the binary code files for the latter contain operation codes of the machine language of the computer architecture 102, the binary code files for the former contain operation codes of the machine language of the pseudo computer architecture 154. Therefore, the computer programs 108′ and the operating system 106′ cannot directly run on the architecture 102, and the computer programs 108 and the operating system 106 cannot run on the pseudo architecture 154.

The pseudo computer architecture 154 may be a random, pseudo-random, or purposefully designed computer architecture. In one embodiment, the pseudo computer architecture 154 is a simple alteration of the existing conventional computer architecture 102, as is described later in the detailed description in more detail. The defining machine language of the pseudo computer architecture 154 is preferably such that there are few or no other computer architectures in existence that have the same machine language. Therefore, computer programs, such as the computer programs 108′ and the operating system 106′ that run on the pseudo computer architecture 154 must have binary code files specifically designed therefor; binary code files for other computer architectures, like the computer architecture 102, preferably do not run on the computer architecture 154. As such, the pseudo computer architecture 154 is non-standard, in that it does not correspond, or is not identical, to any existing computer architecture, such as the computer architecture 102, for which processors exist to understand the machine language thereof. The pseudo computer architecture 154 may further be considered artificial in that it is not formulated as corresponding to an existing or planned~to-be-built hardware computer architecture.

The pseudo nature of the computer architecture 154 introduces computer architecture diversity into the computer system 150 to protect it from being attacked by malicious software developed to run on existing conventional computer architectures. The malicious software 110 is an illustrative example. The malicious, or rogue, software 110 may include one or more computer viruses, worms, logic bombs, rootkits, and Trojan horses, among other types of malicious software known to those of ordinary skill within the art. The malicious software 110 is specifically designed to run on and compromise the existing conventional computer architecture 102. The software development tools, such as toolchains, used to develop legitimate software for the computer architecture 102 can also be employed for illicit purposes to develop the malicious software 110.

The computer architecture 102 may be an inviting target to develop the malicious software 110 if it is the same as the computer architectures of millions or more computer systems around the globe. The malicious software 110 may achieve access to the computer system 100 by virtue of the computer system 100 being connected to other computer systems, such as over the Internet or another type of network. If the computer system 100 is not running any defensive measures against such software, such as firewalls or anti-virus tools, then the malicious software 110 is able to run on the computer architecture 102, as indicated by the arrow 112, and may potentially cause mayhem and mischief to the detriment of the users of the computer system 100.

By comparison, the malicious software 110 inherently cannot run on the pseudo computer architecture 154 where the software 110 has been designed to run on the computer architecture 102, since computer programs able to run on the latter architecture 102 cannot run on the former architecture 154. The malicious software 110 may still be able to obtain access to the computer system 150, due to the computer system 150 being interconnected with other computer systems, such as over the Internet or another type of network. However, even if the computer system 150 is not running any defensive measures against such software, the malicious software 110 is not able to cause problems to the detriment of the users of the computer system 150, because it cannot actually run on the pseudo computer architecture 154. Access of the malicious software 110 to the pseudo computer architecture 154 is indicated by the arrow 114, whereas the inability of the malicious software 110 to run on the pseudo computer architecture 154 is indicated by the letter X 116.

Furthermore, an individual wanting to develop the malicious software 110, so that it is able to run on and attack the computer architecture 154, cannot do so easily. Because the pseudo computer architecture 154 is a non-standard computer architecture that does not correspond to any available existing conventional computer architecture, those with malicious intent cannot easily obtain the machine language defining the pseudo computer architecture 154. Existing software development tools, such as toolchains, used to develop legitimate software for the computer architecture 102 cannot assist the these people in modifying the malicious software 110 to run on the pseudo computer architecture 154 without access to the operation codes of the machine language defining the architecture 154.

At best, those with malicious intent may create random computer architecture machine languages, and generate binary code files for the malicious software 110 that are compatible with such machine languages, in the hope that one of the random machine languages generated matches the machine language of the pseudo computer architecture 154. However, such machine language generation, malicious software binary code file generation, and testing of-the resulting binary codes on the pseudo computer architecture 154 is time-consuming and laborious, and is not guaranteed success. Furthermore, the administrator of the pseudo computer architecture 154 may periodically redefine the machine language of the computer architecture 154—in effect, periodically generating a new computer architecture—and periodically regenerating the binary code files of the computer programs 108′ and the operating system 106′ to run on the redefined architecture 154. Therefore, the pseudo computer architecture 154 becomes a moving target for those with malicious intent, making it even more difficult for the malicious software 110 to be developed to run on the pseudo computer architecture 154.

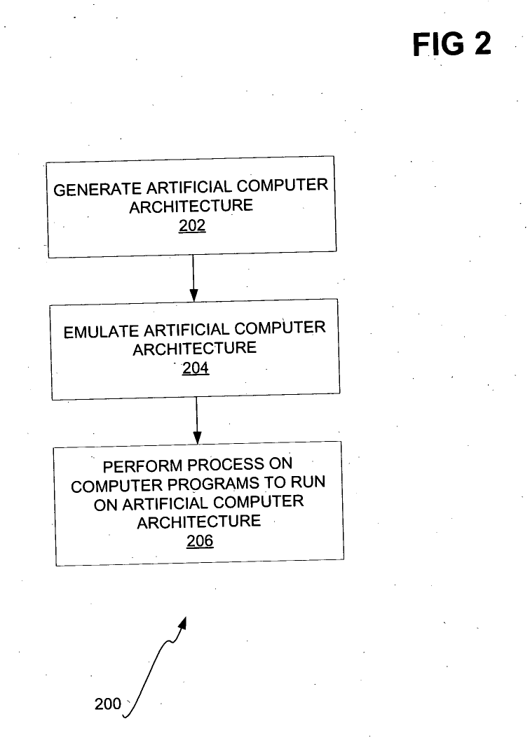

FIG. 2 shows a method 200 for enhancing security of-a computer system through an pseudo computer architecture, according to an embodiment of the invention. At least some parts of the method 200 may be implemented as one or more computer programs, or other types of means, within a computer-readable medium of an article of manufacture. The computer-readable medium may be recordable data storage medium, a modulated carrier signal, or another type of computer-readable medium. The method 200 includes three parts: generating the pseudo computer architecture 154 (202); emulating the pseudo computer architecture 154 (204); and, performing a process on computer programs to run on the pseudo computer architecture 154 (206). Each of these parts of the method 200 is now described in detail.

First, the pseudo computer architecture 154 is generated or defined (202). Generation of the pseudo computer architecture 154 means generating a definition of the computer architecture 154, such as defining the machine language of the pseudo computer architecture 154. The machine language of the pseudo computer architecture 154 includes the operation codes, or opcodes, which are the lowest level codes contained within instructions of binary code files of computer programs meant to be run on the computer architecture 154. As such, defining the machine language for the pseudo computer architecture 154 includes in one embodiment defining the operation codes of the machine language for the pseudo computer architecture 154. Defining the operation codes of the machine language for the pseudo computer architecture 154 can be a random, pseudo-random, or purposefully designed process.

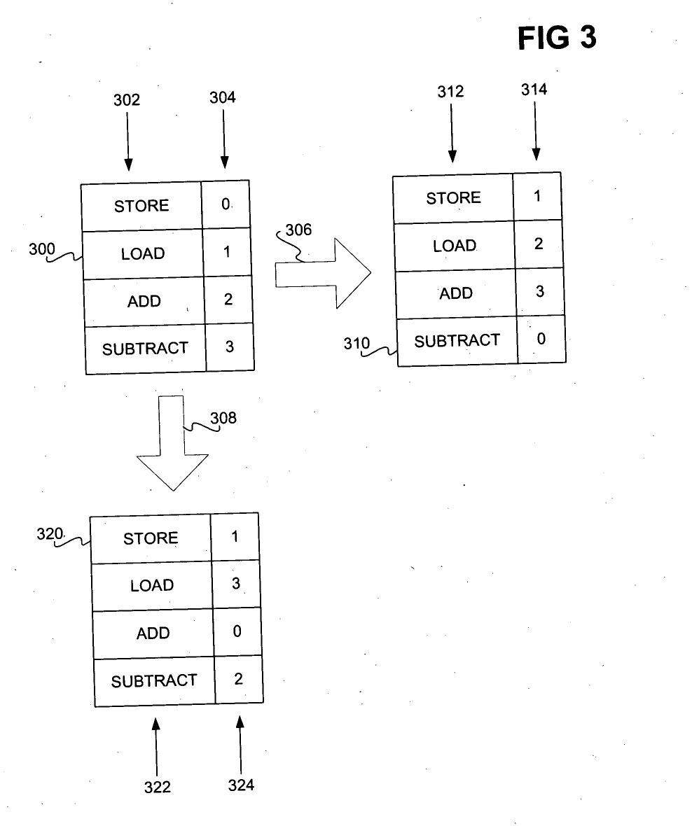

FIG. 3 shows the manner by which two different exemplary machine languages 310 and 320 for the pseudo computer architecture 154 can be generated based on an existing machine language 300 for the existing conventional computer architecture 102, according to an embodiment of the invention. The end result is that the pseudo computer architecture 154 can be considered a modified version of the existing conventional computer architecture 102, according to the examples of the embodiment of FIG. 3. The machine language 300 for the conventional computer architecture 102 includes a number of operation codes indicated in the column 302. Four such operation codes are specifically depicted in FIG. 3 for illustrative convenience. However, in actuality, the machine language 300 for the conventional computer architecture 102 may have 16, 32, 64, 128, 256, or more of such operation codes, as can be appreciated by those of ordinary skill within the art.

Each operation code indicated in the column 302 corresponds to a specific type of command that can be executed by the conventional computer architecture 102. For instance, the store command may store a value in a given memory location, whereas the load command may retrieve a value from a given memory location. The add command may add a value to the value at a given memory location, whereas the subtract command may subtract a value from the value at a given memory location.

The operation codes indicated in the column 302 have corresponding numerical identifiers indicated in the column 304. Therefore, the store, load, add, and subtract commands have the corresponding numerical identifiers zero, one, two, and three. An instruction of a binary code file of a computer program intended to run on the conventional computer architecture 102 indicates a desired operation code by its corresponding numerical identifier. As such, the mapping of the operation codes in the column 302 to the numerical identifiers indicated in the column 304 essentially defines the machine language 300 of the conventional computer architecture 102. Where this mapping is known, the numerical identifier within an instruction of a binary code file is able to indicate which operation code is to be performed by the architecture 102.

Therefore, in one embodiment, the machine language 310 for the pseudo computer architecture 154 is defined by pseudo-randomly altering the mapping of operation codes to numerical identifiers of the machine language 300 for the conventional computer architecture 102, as indicated by the arrow 306. In the example of FIG. 3, the mapping of the machine language 300 is altered pseudo-randomly by incrementing the numerical identifier of each opcode. Therefore, the operation codes of the machine language 310 indicated in the column 312 have corresponding numerical identifiers indicated in the column 314 that are equal to the numerical identifiers indicated in the column 304, plus one. For example, the store operation code in the column 312 of the machine language 310 has the numerical identifier one indicated in the column 314. By comparison, the store operation code in the column 302 of the machine language 300 has the numerical identifier zero indicated in the column 304.

Such straightforward pseudo-random alteration of the machine language 300 for the conventional computer architecture 102 to define the machine language 310 for the pseudo computer architecture 154 is sufficient to prevent binary code files of computer programs designed to run on the former architecture 102 from running on the latter architecture 154. For example, an instruction of a binary code file of a computer program designed to run on the computer architecture 102 may specify the numerical identifier zero to indicate that the store operation code is to be performed, as indicated by the mapping of operation codes in the column 302 to the numerical identifiers in the column 304. However, if this binary code file of this computer program were instead tried to run on the computer architecture 154, the numerical identifier zero specified by this instruction would indicate that the subtract operation code be performed, as indicated by the mapping of operation codes in the column 312 to the numerical identifiers in the column 314. The subtract command, however, is very different than the store command, resulting in the computer program ultimately failing if it attempts to run on the pseudo computer architecture 154.

In another embodiment, the machine language 320 for the pseudo computer architecture 154 is defined by more randomly altering the mapping of operation codes to numerical identifiers of the machine language 300 for the conventional computer architecture 102, as indicated by the arrow 308. In the example of FIG. 3, the mapping of the machine language 300 is altered by randomly mapping numerical identifiers to opcodes. Therefore, the operation codes of the machine language 320 indicated in the column 322 have corresponding numerical identifiers indicated in the column 324 that represent a random scrambling of the operation code-to-numerical identifier mapping indicated in the columns 302 and 304. For example, the load operation code in the column 322 of the machine language 320 has the numerical identifier three indicated in the column 314. By comparison, the load operation code in the column 302 of the machine language 300 has the numerical identifier one indicated in the column 304.

In the example machine languages 310 and 320 for the pseudo computer architecture 154 depicted and described in relation to FIG. 3, the operation codes are thus the same as the operation codes of the machine language 300 for the existing conventional computer architecture 102. The difference is the mapping between operation codes and numerical identifiers is different, by performing a pseudo-random or random process. The mapping between the operation codes and the numerical identifiers may also be accomplished via a purposefully designed process. For example, a developer may manually map operation codes to numerical identifiers as desired to generate the machine language for the pseudo computer architecture 154.

Furthermore, in another embodiment, the machine language for the pseudo computer architecture 154 may be purposefully designed in that the operation codes themselves may be partially or completely different than those of machine languages for existing or conventional computer architectures. For instance, new commands, having new operation codes, may be created or generated. Once such new operation codes are created, a mapping is still achieved between the operation codes and numerical identifiers, so that instructions of binary code files for computer programs to run on the pseudo computer architecture 154 can properly indicate which operation codes are to be performed. Other processes for defining the machine language for the pseudo computer architecture 154, by altering the machine language for conventional computer architectures or by creating entirely new machine languages, may also be performed.

Referring back to FIG. 2, the method 200 next emulates the pseudo computer architecture 154 (204). The system 150 of FIG. I that has been described shows one manner by which the pseudo computer architecture can be emulated. A software-, hardware-, or both software-and-hardware-implemented emulator 152 is present, which translates operation codes of the pseudo computer architecture 154 to corresponding operation codes of the conventional computer architecture 102 understood and executable by the processors 104 of the latter architecture 154.

For example, the machine language of the pseudo computer architecture 154 may be the machine language 320 of FIG. 3, whereas the machine language of the conventional computer architecture 102 may be the machine language 300 of FIG. 3. An instruction of the binary code files of one of the computer programs 108′ or of the operating system 106′ may specify the numerical identifier zero, to indicate that the add command of the add operation code is to be performed within the pseudo computer architecture 154. The emulator 152, in receiving the numerical identifier zero, translates this numerical identifier to the numerical identifier two, which is the numerical identifier of the add operation code of the machine language 300 for the conventional computer architecture 102.

In this way, the emulator 152 allows the conventional computer architecture 102 to emulate the pseudo computer architecture 154. That is, the emulator 152 enables the conventional computer architecture to effectively implement the pseudo computer architecture 154. Employing the emulator 152 means that the developer of the pseudo computer architecture 154 does not actually have to create new hardware, such as new processors, that is able to understand the operation codes of the machine language for the pseudo computer architecture 154. Rather, the developer only has to appropriately configure the emulator 152 so that numerical identifier-to-operation code mappings of the machine language for the pseudo computer architecture 154 are translated to corresponding numerical identifier-to-operation code mappings of the machine language for the conventional computer architecture 102.

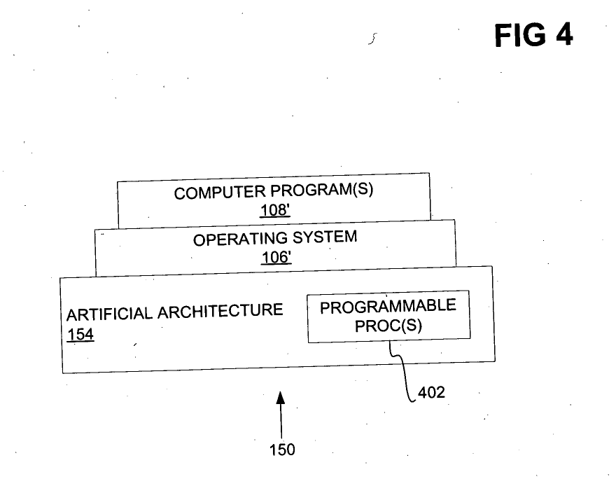

FIG. 4 shows the computer system 150 including the pseudo computer architecture 154, according to another embodiment of the invention by which emulation of the pseudo computer architecture 154 can be achieved. In the embodiment of FIG. 4, the computer system 150 does not include an emulator like the emulator 152 of FIG. 1.

Rather, the pseudo computer architecture 154 is actually implemented in hardware, by using one or more programmable processors 402, for example. The programmable processors 402 are flexible processors that can have their operation code-to-numerical identifier mappings redefined relatively easily. Therefore, once the developer of the pseudo computer architecture 154 has generated the machine language for the computer architecture 154, he or she only has to correspondingly program or configure the programmable processors 402 so that they are compatible with computer architecture 154.

The advantage of using the emulation approach for the computer system 150 in FIG. 4 is that performance of the pseudo computer architecture 154 may be better. Conversely, the advantage of using the emulation approach for the computer system 150 in FIG. 1 is that the existing conventional computer architecture 102 may be more readily accessible. Implementation of the pseudo computer architecture 154 on the conventional computer architecture 102, using the emulator 152, may thus be more cost effective.

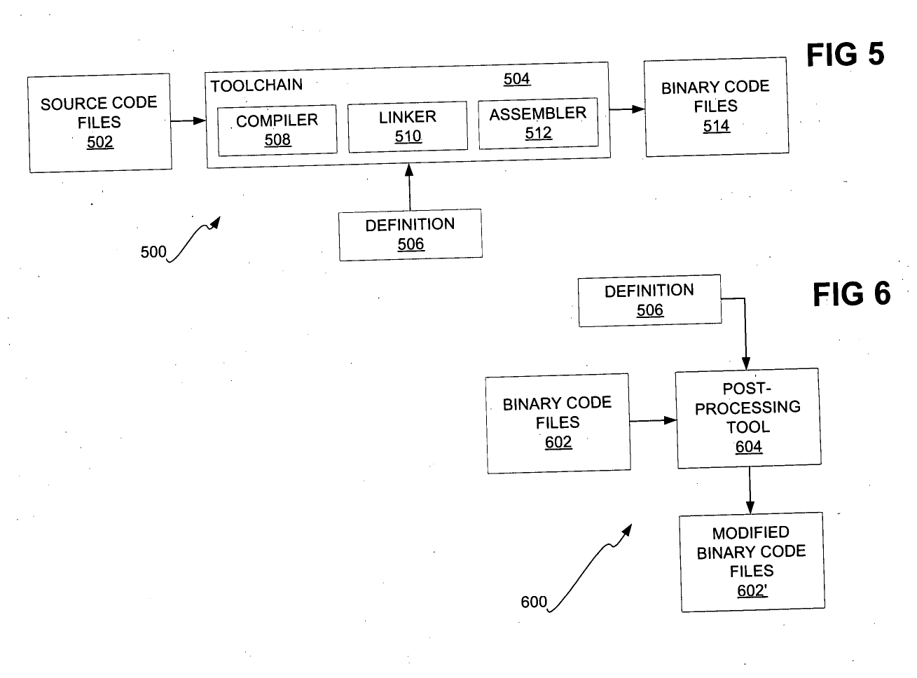

Referring back to FIG. 2, the method 200 finally performs a process on computer programs so that they are able to run on the pseudo computer architecture 154 (206). FIG. 5 illustratively depicts one such process 500 to enable computer programs to run on the pseudo computer architecture 154, according to an embodiment of the invention. The source code files 502 are developer-written and user-readable files of a computer program. For instance, the computer program may be one of the computer programs 108′, or the operating system 106′. Furthermore, the source code files 502 may be identical to those for the corresponding computer programs 108′, or the corresponding operating system 106′. For example, if the source code files 502 are for the one of the computer programs 108′, then they may also be the source code files for the corresponding one of the computer programs 108. This is because the compilation process causes the computer programs 108 to be generated from the source code files 502 to run on the operating system 106, and the computer programs 108′ to be generated from the source code files 502 to run on the operating system 106′. That is, the developer-written and user-readable files may be used to generate both the computer programs 108′ runnable on the pseudo computer architecture 154, as well as the computer programs 108 runnable on the conventional computer architecture 102.

The source code files 502 are input into a toolchain 504. The toolchain :504 is more generally one or more computer programs, or tools, that generate the binary code files 514 for a computer program from the source code files 502 for the computer program, based on a definition 506 of the computer architecture on which the binary code files 514 for the computer program are to be executed. The toolchain 504 is depicted in FIG. 5 as exemplarily including a compiler 508, a linker 510, and/or an assembler 512.

The compiler 508 may generally and non-restrictively be considered as software that converts the high-level language statements of the source code files 502 for a computer program into a lower-level representation of the computer program. The linker 510 may generally and non-restrictively be considered as a utility program that links a compiled or assembled computer program to a particular environment, platform, or computer architecture. The linker 510 may also be referred to as a link editor, and unites references between program modules and libraries of subroutines. Its output may be the binary code files, which are executable on a given computer architecture.

The assembler 512 may generally and non-restrictively be considered as software that translates assembly language into machine language. The assembler 512 thus contrasts with the compiler 508 in that the latter may be used to translate a high-level language, such as COBOL or C, into assembly language first and then into machine language using the assembler 512, or the compiler 508 may translate the high-level language directly into machine language. Assembly language is a programming language that is one step away from machine language. Each assembly language statement is translated into one operation code by the assembler 512. Although often used synonymously, assembly language and machine language are not the same as used herein. Assembly language is turned into machine language. For example, the assembly instruction COMPARE A, B may be translated into COMPARE contents of the memory location 23402350 with the contents of the memory location 45674577, where A and B happen to be located. The physical binary format of the machine language instruction is specific to the computer architecture on which it is running.

The definition 506 for the pseudo computer architecture 154, such as the machine language of the computer architecture 154, including its list of operation codes and the mapping of such codes to numerical identifiers, is input into the toolchain 504 along with the source code files 502. The output of the toolchain 504 is the binary code files 514 for the computer program having the source code files 502, where the binary code files 514 are executable only on the pseudo computer architecture 154 due to the definition 506 thereof being unique to the computer architecture 154. It can be said that in one embodiment the toolchain 504 is modified based on the definition 506 of the pseudo computer architecture 154, insofar as the toolchain 504 generates the binary code files 514 executable on the computer architecture 154 from the source code files 502 specifically based on the definition of the computer architecture 154. Alternatively, in another embodiment of the invention, a toolchain that is particular to the existing conventional computer architecture 102 may be modified so that the binary code files it generates are executable on the pseudo computer architecture 154, instead of on the conventional computer architecture 102.

FIG. 6 illustratively depicts another process 600 to enable computer programs to run on the pseudo computer architecture 154, according to an embodiment of the invention. The binary code files 602 are for a computer program running on the conventional computer architecture 102 that is desired to instead be run on the pseudo computer architecture 154. For instance, the binary code files 602 may be for the operating system 106. The binary code files 602 are input into a post-processing tool 604, as is the definition 506 for the pseudo computer architecture 154. The post-processing tool 604 then modifies the binary code files 602, based on the definition 506 for the pseudo computer architecture 154, so that the modified binary code files 602′ that are output run on the pseudo computer architecture 154. The post-processing tool 604 is considered a post-processing tool in that it performs its processing after, for instance, a compiler, a linker, and/or an assembler of a toolchain 4 have performed their processing.

The post-processing tool 604 may be particular to a given existing conventional computer architecture, such as the computer architecture 102, so that it is able to modify binary code files, such as the binary code files 602, that are executable on this conventional computer architecture to instead run on the pseudo computer architecture 154 specified by the definition 506. Alternatively, the post-processing tool 604 may also receive as input the definition of an existing conventional computer architecture, such as the machine language thereof, including a list of operation codes and mappings between operation codes and numerical identifiers. Based on this definition of the existing conventional computer architecture, on which the binary code files 602 are executable, and based on the definition 506 of the pseudo computer architecture 154, the post-processing tool 604 modifies the binary code files 602 to generate the modified binary code files 602′ executable on the pseudo computer architecture 154.

As another alternative, the post-processing tool 604 may just receive as input the remapping of operation codes to identifiers between the machine language for the conventional computer architecture on which the binary code files 602 run and the machine language for the pseudo computer architecture 154. That is, the post-processing tool 604 may not receive as input the actual definition 506 of the pseudo computer architecture 154. Based on the input remapping, the post-processing tool 604 is able to modify the binary code files 602 runnable on the conventional computer architecture to binary code files 602′ runnable on the pseudo computer architecture 154. Generally, the input of this remapping, the input of the definition 506 for the pseudo computer architecture 154, and/or the input of the definition for the conventional computer architecture on which the binary code files 602 currently run can be considered as configuring the post-processing tool 604 so that it is able to alter the binary code files 602 to run on the pseudo computer architecture 154 as the binary code files 602′.

It is noted that, although specific embodiments have been illustrated and described herein, it will be appreciated by those of ordinary skill in the art that any arrangement calculated to achieve the same purpose may be substituted for the specific embodiments shown. This application is intended to cover any adaptations or variations of embodiments of the present invention. It is manifestly intended that this invention be limited only by the claims and equivalents thereof.

I claim:

1. A method comprising:
generating an pseudo computer architecture;
emulating the pseudo computer architecture; and,
performing a process to allow one or more computer programs to run on the pseudo computer architecture.

2. The method of claim 1, wherein generating the pseudo computer architecture comprises generating a non-standard computer architecture.

3. The method of claim 1, wherein generating the pseudo computer architecture comprises modifying an existing computer architecture.

4. The method of claim 1, wherein generating the pseudo computer architecture comprises generating a plurality of operation codes for the pseudo computer architecture.

5. The method of claim 4, wherein generating the plurality of operation codes for the pseudo computer architecture comprises altering a plurality of operation codes of an existing computer architecture.

6. The method of claim 4, wherein emulating the pseudo computer architecture comprises programming a programmable processor with the plurality of operation codes for the pseudo computer architecture.

7. The method of claim 1, wherein emulating the pseudo computer architecture comprises emulating the pseudo computer architecture via software running on an existing computer architecture.

8. The method of claim 1, wherein emulating the pseudo computer architecture comprises emulating the pseudo computer architecture via hardware.

9. The method of claim 1, wherein performing the process to allow the computer programs to run on the pseudo computer architecture comprises generating executable binary files for the computer programs from source code files for the computer programs, based on a machine language of the pseudo computer architecture.

10. The method of claim 9, wherein performing the process to allow the computer programs to run on the pseudo computer architecture further comprises modifying one or more of a compiler, an assembler, and a linker, based on the machine language of the pseudo computer architecture.

11. The method of claim 1, wherein performing the process to allow the computer programs to run on the pseudo computer architecture comprises modifying executable binary code files for the computer programs that are runnable on an existing computer architecture, based on a-machine language of the pseudo computer architecture, so that the executable binary code files are runnable on the pseudo computer architecture.

12. The method of claim 11, wherein modifying the executable binary code files that are runnable on the existing computer architecture comprises configuring a post-processing programming tool to alter the executable binary code files to run on the pseudo computer architecture instead of the existing computer architecture.

13. A system comprising:
an pseudo computer architecture that is different than existing computer architectures so that malicious software written to run on the existing computer architectures is unable to run on the pseudo computer architecture;
one or more computer programs originally intended to run on an existing computer architecture and that have been modified to instead run on the pseudo computer architecture.

14. The system of claim 13, further comprising an emulator to emulate the pseudo computer architecture in software so that the pseudo computer architecture is implementable with existing hardware.

15. The system of claim 13, further comprising a hardware emulator to emulate the pseudo computer architecture.

16. The system of claim 15, wherein the hardware emulator comprises a programmable processor programmed in accordance with the pseudo computer architecture.

17. The system of claim 13, wherein the pseudo computer architecture comprises a modified version of an existing computer architecture.

18. The system of claim 17, wherein the pseudo computer architecture comprises a plurality of operation codes that are generated by altering a plurality of operation codes of the existing computer architecture.

19. An article of manufacture comprising:
a computer-readable medium; and,
means in the medium for providing an pseudo computer architecture that is different than existing computer architectures so that malicious software written to run on the existing computer architectures is unable to run on the pseudo computer architectures,
wherein computer programs originally intended to run on an existing computer architecture have to be modified to instead be run on the pseudo computer architecture.

20. The article of claim 19, wherein the computer-readable medium is one of a recordable data storage medium and a modulated carrier signal.
